(19) United States
(12) Patent Application Publication
(10) Pub. No.: US 2008/0229488 A1
(43) Pub. Date: Sep. 25, 2008

(54) Inner Shell for Safety Helmets and Method of Producing the Same

(75) Inventor: Jong-Kee Kim, Gyeonggi-do (KR)

Correspondence Address: Daniel P Burke & Associates, PLLC, 300 Rabro Drive, Suite 131, Hauppauge, NY, 11788, US

(73) Assignee: SANCHEONG CO., LTD., Yongin-Si, Gyeonggi-Do (KR)

(21) Appl. No.: 10/586,092

(22) PCT Filed: Jun. 14, 2004
(86) PCT No.: PCT/KR2004/001409

§ 371 Date: Jul. 13, 2006

(30) Foreign Application Priority Data
Jan. 14, 2004 (KR) 10-2004-0002573

(51) Int. Cl. A42B 3/00; B28B 5/00

(52) U.S. Cl. 2/412; 2/411; 264/250; 264/241

(57) ABSTRACT

Disclosed is an inner shell for safety helmets, which is massproduced and has a structure capable of efficiently absorbing and dispersing an impact, and a method of producing the same, which ensures the reduced material costs and the improved workability and productivity. The inner shell (10) includes a liner member (12) having openings at upper and lower parts thereof, and an impact absorbing member (14) surrounding a circumference of the liner member (12). The method includes injection-molding a molten plastic resin into a predetermined shape of liner member (12), putting the molded liner member (12) in a metal mold, forming the impact absorbing member (14) using a foamed resin, including Styrofoam, a polyethylene foam, and a urethane foam, in the metal mold after the metal mold is hermetically sealed, separating the inner shell (10) from the metal mold, and finishing the inner shell (10).

### TECHNICAL FIELD

The present invention relates, in general, to an inner shell for safety helmets and a method of producing the same and, more particularly, to an inner shell for safety helmets, which can be massproduced and has a structure capable of efficiently absorbing and dispersing an impact, and a method of producing the same, which ensures reduced material costs and improved workability and productivity.

### BACKGROUND ART

Generally, a worker wears a safety helmet for safety where exposed to hazards, such as workings, fields of a construction work, and scenes of fire. With respect to this, the safety helmet serves to prevent the worker from being injured by protecting a worker's head when an impact occurs.

In this regard, it is necessary to design a safety helmet so that it is light enough in weight to enable the worker wearing the safety helmet to feel comfortable and has strength sufficient to protect the worker's head from an impact.

Referring to FIG. 1, a conventional safety helmet is provided with a hemispherical outer shell 1 covering a user's head, an inner shell 2 attached to an inner surface of the outer shell 1, a headband 3, a suspension band 4, and a chin strap 5 to secure the safety helmet on the user's head.

The inner shell 2 mounted in the outer shell 1 is typically produced in a shape of a hemisphere according to a vacuum molding process, and an impact absorbing member 2a, made of a foamed resin, such as Styrofoam, a polyethylene (PE) foam, and a urethane foam, is interposed between the inner and outer shells 2, 1 to shield the user's head from an impact.

In the vacuum molding process, a heated and softened plastic resin is molded into a predetermined shape of the product under atmospheric air. In detail, after the plastic resin is put in a metal mold, heated and softened, a space between the metal mold and plastic resin is vacuumized to enable the plastic resin to adhere closely to the metal mold to produce a desired design of product. Subsequently, the product is cooled, and then separated from the metal mold by injecting air between the metal mold and the product.

However, the vacuum molding process is problematic in that it takes a significantly long time to heat, then soften, and finally cool the plastic resin. Accordingly, a production time of the inner shell 2 is relatively long, the productivity is reduced, and the workability is reduced because an amount of work required to produce the inner shell 2 is increased.

Furthermore, since the inner shell 2 is of a hemispherical shape like the outer shell 1, the impact energy is dispersed on the entire inner shell 2, and thus, it is difficult to reduce the impact energy. As well, the user may feel discomfort because a space between the user's head and the conventional safety helmet is poorly ventilated when the user wears the conventional safety helmet.

Moreover, the hemispherical shape of the inner shell 2 makes weight reduction of the conventional safety helmet difficult.

### DISCLOSURE OF THE INVENTION

Accordingly, the present invention has been made keeping in mind the above problems occurring in the prior art, and an object of the present invention is to provide an inner shell for a safety helmet, which has a structure capable of efficiently absorbing and dispersing an impact to protect a user's head from the impact, and a method of producing the same, in which a liner member constituting the inner shell is simply produced in a shape suited to the user's head through an injection molding process, thereby reducing a time required to produce the inner shell and improving the productivity.

Another object of the present invention is to provide an inner shell for a safety helmet, which has a structure capable of well ventilating a space between a user's head and a safety helmet, and a method of producing the same, which reduces a weight of the safety helmet to reduce production costs of the safety helmet.

In order to accomplish the above object, the present invention provides an inner shell for a safety helmet, which is provided with a liner member and an impact absorbing member, and a method of producing the same. At this time, the liner member has openings at upper and lower parts thereof and is produced in a shape suited to a user's head through an injection molding process. Furthermore, the impact absorbing member is formed around a circumference of the liner member according to a foaming process. With respect to this, the method includes injection-molding a molten plastic resin into a predetermined shape of a liner member, putting the molded liner member in a foaming metal mold, and forming the impact absorbing member using a foamed resin, such as Styrofoam, a PE foam, and a urethane foam, around the circumference of the liner member in the foaming metal mold.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates a conventional safety helmet;

FIG. 2 is an exploded perspective view of a safety helmet according to the present invention;

FIG. 3 is a side sectional view of an inner shell for the safety helmet according to the first embodiment of the present invention;

FIG. 4 is an exploded view of the safety helmet, which illustrates the assembly of the inner shell, according to the first embodiment of the present invention, with the safety helmet;

FIG. 5 illustrates the production of the inner shell for the safety helmet according to the first embodiment of the present invention;

FIG. 6 is a flow chart illustrating the production of the inner shell for the safety helmet according to the first embodiment of the present invention; and

FIG. 7 illustrates an inner shell for the safety helmet according to the second embodiment of the present invention.

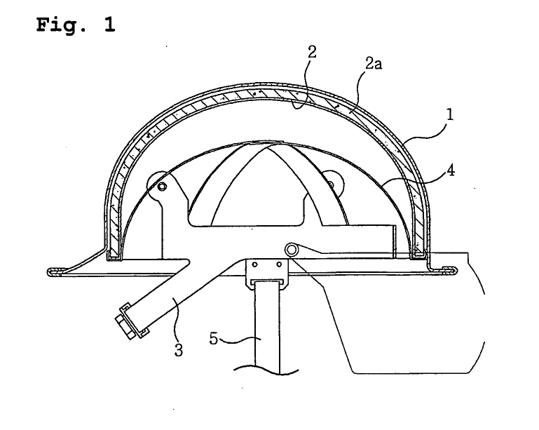

### BEST MODE FOR CARRYING OUT THE INVENTION

Reference should now be made to the drawings, in which the same reference numerals are used throughout the different drawings to designate the same or similar components.

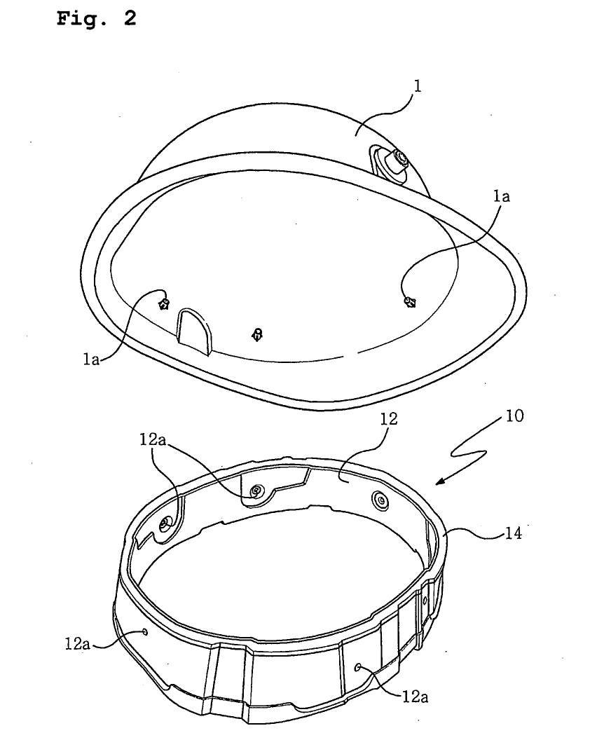

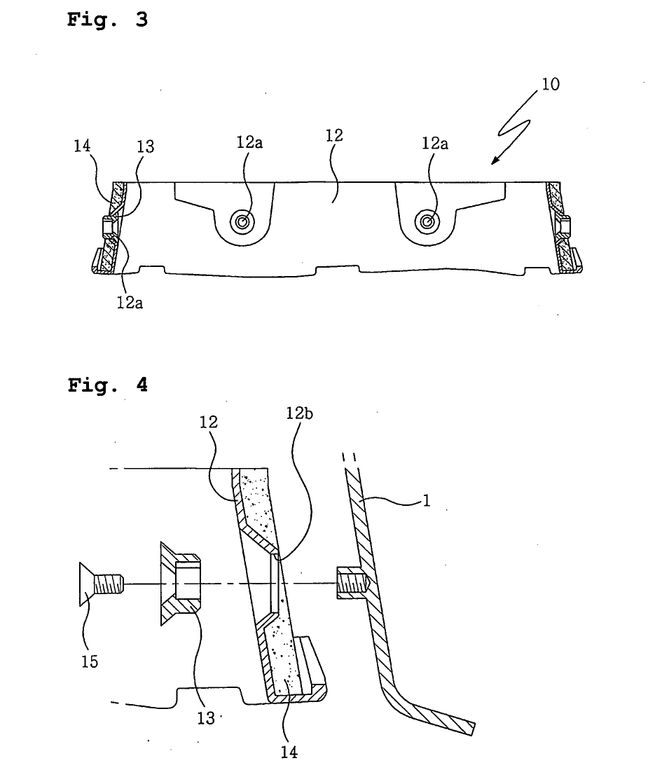

FIG. 2 is an exploded perspective view of a safety helmet according to the present invention, FIG. 3 is a side sectional view of an inner shell for the safety helmet according to the first embodiment of the present invention, and FIG. 4 is an exploded view of the safety helmet, which illustrates the assembly of the inner shell, according to the first embodiment of the present invention, with the safety helmet.

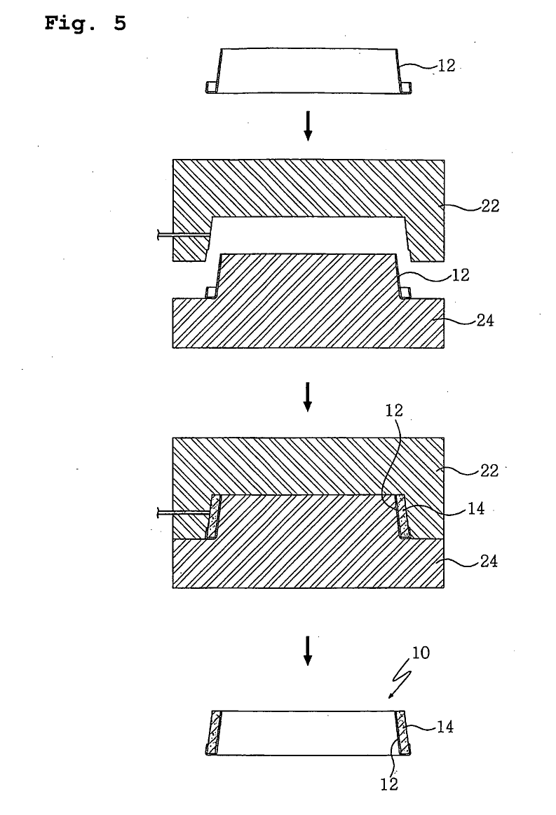

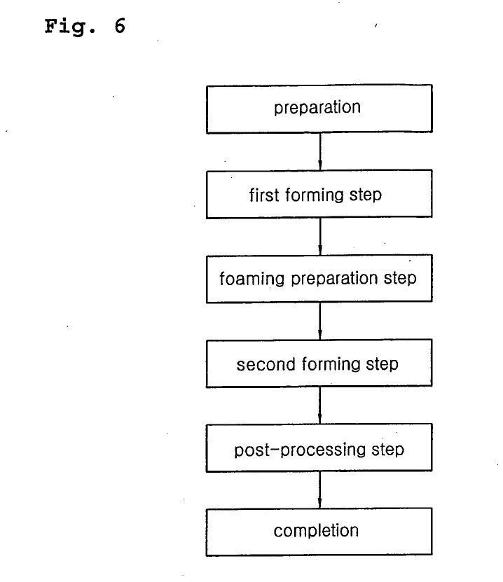

Additionally, FIG. 5 illustrates the production of the inner shell for the safety helmet according to the first embodiment of the present invention, and FIG. 6 is a flow chart illustrating the production of the inner shell for the safety helmet according to the first embodiment of the present invention.

With reference to FIGS. 2 and 3, the inner shell 10 according to the present invention includes a headband-shaped liner member 12, and an impact absorbing member 14 surrounding a circumference of the liner member 12. In this regard, the liner member 12 is opened at upper and lower parts thereof.

The liner member 12 is produced in a shape suited to a user's head by injection-molding a rigid plastic resin, and a plurality of first and second holes 12a, 12b, through which bolts 15 are to be passed, are formed through side, and front and rear walls of the liner member 12.

At this time, the bolts 15 are each screwed through the second hole 12b, formed through the front and rear walls of the liner member 12, into an internally threaded projection 1a, inwardly protruded from an inner surface of an outer shell 1, and in which a bushing 13 mounted in the second hole 12b is engaged around the internally threaded projection 1a to enable each bolt 15 to be easily screwed into the internally threaded projection 1a as shown in FIG. 4.

Furthermore, the impact absorbing member 14 surrounding the circumference of the liner member 12 is made of a foamed resin, such as Styrofoam, a PE foam, and a urethane foam.

In this respect, the impact absorbing member 14 may be formed by directly foaming a resin material for foam use around the circumference of the liner member 12, or may be attached to the circumference of the liner member 12 after it is produced in a form of an attachment member.

The inner shell 10 of the safety helmet and other components are assembled with the outer shell 1 by screwing the bolts 15 through the first and second holes 12a, 12b of the inner shell 10 into the internally threaded projections 1a.

As shown in FIGS. 5 and 6, a method of producing the inner shell 10 includes a first forming step of injection-molding the molten plastic resin into a predetermined shape of liner member 12 which is opened at upper and lower parts thereof; a foaming preparation step of putting the liner member 12, molded through the first forming step, in the metal mold; a second forming step of forming the impact absorbing member 14 using the foamed resin, including Styrofoam, the polyethylene foam, and the urethane foam, in the metal mold after upper and lower mold frames 22, 24 constituting the metal mold are hermetically sealed; and a post-processing step of separating the inner shell 10, formed through the second forming step, from the metal mold, and finishing the inner shell 10 separated from the metal mold.

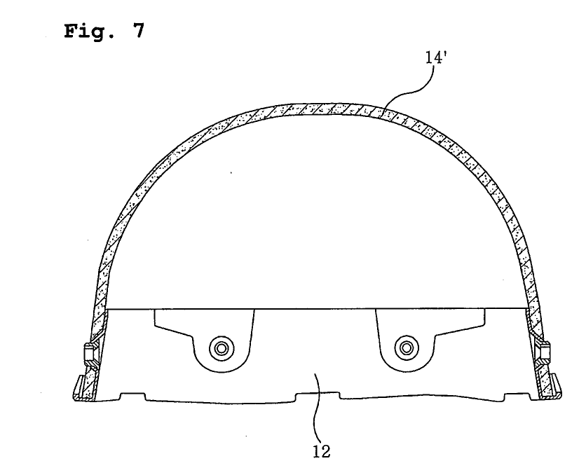

Meanwhile, FIG. 7 illustrates an inner shell for the safety helmet according to the second embodiment of the present invention, in which a hemispherical impact absorbing member 14′ is provided at the outer circumference of the liner member 12.

Hereinafter, a description will be given of the production of the inner shell for the safety helmet according to the present invention.

Referring to FIGS. 5 and 6, the headband-shaped liner member 12, which is opened at the upper and lower parts thereof and molded according to a typical injection molding process, is put into the foaming metal mold equipped with the upper and lower mold parts 22, 24.

After the foaming metal mold equipped with the upper and lower mold parts 22, 24 is hermetically sealed, the resin material is foamed around the circumference of the liner member 12 to form the impact absorbing member 14 around the circumference of the liner member 12 to accomplish the inner shell 10. At this time, the impact absorbing member 14 is made of the foam resin material, such as Styrofoam, the PE foam, or the urethane foam.

The inner shell 10 for the safety helmet and other components are assembled with the outer shell 1, constituting the safety helmet, by screwing the bolts 15 through the first and second holes 12a, 12b of the liner member 12 into the internally threaded projections 1a.

In this regard, the bolts 15 each are screwed through the second hole 12b, formed through the front and rear walls of the liner member 12, into the internally threaded projection 1a, and the bushing 13 mounted in the second hole 12b serves to enable each bolt 15 to be easily screwed into the internally threaded projection 1a.

As well, since the inner shell 10 assembled with the inner surface of the outer shell 1 is opened at the upper and lower parts thereof, when a user wears the safety helmet, the space between the safety helmet and a user's head has better ventilation, thereby smoothly discharging sweat from the safety helmet.

With respect to this, the safety helmet of the present invention was tested for an impact absorbing ability according to a safety inspection standard, and the results, including impact energy flowing through the safety helmet, are described in the following Table 1.

TABLE 1

| | | | | | Results | | |
|---|---|---|---|---|---|---|---|
| | | | | | Inven- | Conven- | Test |
| Test item | | | Unit | Standard | tion | tional | method |
| Impact | High | C | N | 4.450 | 1779 | 1948 | Note |
| absorbing | temp. | R | | or less | 2060 | 3225 | |
| ability | | L | | | 1948 | 2282 | |
| | | F | | | 2224 | 2727 | |
| | | B | | | 2060 | 2669 | |
| | Low | C | | | 3500 | 2891 | |
| | temp. | R | | | 2727 | 3616 | |
| | | L | | | 2669 | 3283 | |
| | | F | | | 2891 | 2780 | |
| | | B | | | 2891 | 3003 | |

| | | | | | |
|---|---|---|---|---|---|
| ¹Resist- | High | mm | ²ABE | 9.5 or | 9.5 or |
| ance | temp. | | | less | less |
| | Low | | ³AB | 9.5 or | 9.5 or |
| | temp. | | | less | less |

¹Resistance; resistance to impact energy flowing through the safety helmet
²ABE; ABE-type: 9.5 or less
³AB; AB-type: 11.1 or less

From the Table 1, it can be seen that the safety helmet provided with the inner shell 10 of the present invention efficiently absorbs and disperses an impact and thereby safely shields the user's head from the impact.

Furthermore, since the inner shell of the present invention is opened at the upper and lower parts thereof, a weight of the safety helmet and material costs of the inner shell are reduced, and the workability and productivity are improved due to the simplified production method of the inner shell 10.

Moreover, the liner member 12 constituting the inner shell 10 is simply produced according to the typical injection molding process, and thus, a production time of the inner shell 10 is reduced and the inner shell 10 can be massproduced.

### INDUSTRIAL APPLICABILITY

As described above, the present invention provides an inner shell for a safety helmet, which is provided with a liner member and an impact absorbing member, and a method of producing the same. In this regard, the inner shell has a structure capable of efficiently absorbing and dispersing an impact to safely shield a user's head from an impact, and since the liner member is simply produced through an injection molding process, a time required to produce the inner shell is reduced and the productivity is improved.

Additionally, the inner shell of the present invention contributes to significantly reducing a weight and production costs of the safety helmet.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An inner shell for a safety helmet, which includes the inner shell and an outer shell, comprising:
a liner member opened at upper and lower parts thereof; and
an impact absorbing member surrounding a circumference of the liner member.

2. The inner shell as set forth in claim 1, wherein a plurality of first and second holes, through which bolts are to be passed, are formed through side, and front and rear walls of the liner member, and bushings are mounted in the second holes formed through the front and rear walls of the liner member.

3. The inner shell as set forth in claim 1, wherein the impact absorbing member is formed by foaming a resin material for foam use around the circumference of the liner member, the impact absorbing member being made of a foamed resin, including Styrofoam, a polyethylene foam, and a urethane foam.

4. The inner shell as set forth in claim 1, wherein the impact absorbing member is produced in a form of an attachment member and is attached to the circumference of the liner member.

5. A method of producing an inner shell for a safety helmet, comprising:
a first forming step of injection-molding a molten plastic resin into a predetermined shape of liner member, the liner member being opened at upper and lower parts thereof;
a foaming preparation step of putting the liner member, molded through the first forming step, in a metal mold;
a second forming step of forming an impact absorbing member using a foamed resin, including Styrofoam, a polyethylene foam, and a urethane foam, in the metal mold after the metal mold is hermetically sealed; and
a post-processing step of separating the inner shell, formed through the second forming step, from the metal mold, and finishing the inner shell separated from the metal mold.
